(19) United States
(12) Patent Application Publication
(10) Pub. No.: US 2025/0065431 A1
(43) Pub. Date: Feb. 27, 2025

(54) PROTECTIVE WELDING NOZZLE

(71) Applicant: Kenneth GERHART, Hixson, TN (US)

(72) Inventor: Kenneth GERHART, Hixson, TN (US)

(21) Appl. No.: 18/236,052

(22) Filed: Aug. 21, 2023

(51) Int. Cl. B23K 9/16

(52) U.S. Cl. CPC B23K 9/164

(57) ABSTRACT

A welding nozzle includes a body having an upper portion and a lower portion. The upper portion is configured to engage with an end portion of a welding gun or torch. The lower portion defines an electrode receiving aperture, and a plurality of gas ports.

### TECHNICAL FIELD

The present invention relates generally to welding devices and, more particularly, to a welding nozzle for use on a gas metal arc welding gun that inhibits spatter from accumulating on the welding gun and consumables thereof.

### BACKGROUND

Welding is used for many purposes, the most common being to join two pieces of metal together. In such a process, abutting edges of the two pieces of metal are heated to an elevated temperature until they become molten, and a bead of molten metal is deposited from a welding rod or electrode along the molten edges to fuse the edges together. When the metal cools, it solidifies to form a unitary bond.

Many types of welding systems have been developed over the years. The most common are electric arc welding and gas welding. Gas Metal-Arc Welding (GMAW) (also known as Metal Inert Gas (MIG) or Metal Active Gas (MAG)) is a process in which heat for welding is generated by an arc extending between a consumable electrode and the work metal. The electrode is an electrically conductive, metal wire that melts due to electrical current passing through the wire and to the material (e.g., workpiece) to be welded, which completes the circuit. The electrode is continuously fed to the weld area and generally takes the form of a filler material that is consumed during welding. The weld zone (e.g., electrode, weld puddle, arc, and adjacent areas of the base metal) is protected from atmospheric contamination by a stream of shielding gas (e.g., emitted by the welding gun) comprising a mixture of inert and reactive gases, for example, a mixture of 90% argon and 10% carbon dioxide.

A conventional GMAW gun or torch is shown in FIG. 1. The welding gun 10 is attached to a wire feeder 12, which feeds the consumable electrode wire 14 through the gun 10. The welding gun 10 is provided with a nozzle 16, which generally surrounds a contact tip 18 via a circumferential side wall 15 thereof. The contact tip 18 directs the consumable electrode wire 14 from the welding gun 10 and transfers current therethrough via a conductor tube (not shown) and to the workpiece being welded. A shielding gas mix, such as an argon/CO₂ mix or an argon/O₂ mix is supplied to the welding gun and is emitted through an opening 13 of the nozzle 16 to form a shield around the arc and weld pool when welding. A constant voltage power supply 20 is provided to direct current to the contact tip 18 via the welding gun 10, which is typically connected to a positive terminal of the power source. A work clamp connected to a negative terminal of the power source is secured to the workpiece 22 to establish a closed circuit. The result of the arc that is created when current is transmitted through the electrode wire 14 causes the tip of the wire 14 to melt and be deposited on the metal surface 22 being welded. As mentioned above, the shielding gas 26 shields the molten metal from atmospheric gases (e.g., oxygen and nitrogen) that would negatively affect the weld quality.

One difficulty associated with GMAW is that the process may generate substantial weld spatter, for example, due to an improper wire feed speed and/or voltage setting or the type of shielding gas being utilized (e.g., a rich CO₂ mixture). In such instances, spatter may enter the nozzle 16 through the front opening 13 thereof and adhere to the nozzle 16 and/or other consumables therein (e.g., the contact tip 18, a gas diffuser (not shown), etc.). Accumulation of spatter on the interior of the welding nozzle 16 and on the surface of the contact tip is problematic. For instance, spatter adhered to a surface of the contact tip 18 may undesirably cause “burn back,” wherein the welding wire 14 burns back and sticks to the contact tip 18, inhibiting further welding (and wire transfer) until the contact tip is either cleaned or replaced. This results in significant downtime. In addition, spatter can solidify as slag on the interior wall of the welding nozzle 18, thereby reducing the size of the inner bore and smoothness of the nozzle 18. The reduced size of the inner bore may impede the flow of shielding gas to the welding zone and/or undesirably alter the flow dynamics thereof, leading to inadequate shielding coverage and/or weld quality issues (e.g., due to porosity in the weld). The accumulation of welding spatter on welding gun consumables creates inefficiencies in the welding process due to the downtime incurred for periodic cleanings and/or consumable replacements (e.g., of contact tips, nozzles, and the like).

These problems are exacerbated in robotic welding applications, which often require time-consuming programming requirements, for example, for recurring torch cleaning performed by torch cleaning/reaming stations adjacent the welding cell. Moreover, a robot welding station generally will not resume welding from where a weld problem has occurred. In many instances, after a tip related problem, the operator loads another part to be welded and places the unfinished part in another work station, wherein the part is manually welded, increasing the overall manufacturing cost (e.g., cost per part).

Accordingly, a need exists for a new and improved welding nozzle, which overcomes the above-referenced problems and others.

### SUMMARY OF THE INVENTION

In accordance with one aspect of the invention, a welding nozzle includes a body having an upper portion and a lower portion. The upper portion is configured to engage with an end portion of a welding torch or gun. The lower portion defines an electrode receiving aperture and a plurality of gas ports extending therethrough.

In accordance with another aspect of the invention, a welding nozzle includes an upper portion and a lower portion. The upper portion is engageable with an end portion of a welding torch or gun, and the tapered lower portion defines an electrode receiving aperture and a plurality of shielding gas ports.

In accordance with another aspect of the invention, a method of assembling a welding gun or torch includes connecting a welding nozzle to an end portion of the welding gun or torch. The welding nozzle includes a nozzle body having an upper portion and a lower portion. The upper portion is engageable with the end portion of the welding gun or torch, and the lower portion includes a circumferential side wall intersecting an end wall. The circumferential side wall and the end wall each define a plurality of gas diffusion holes therethrough.

### BRIEF DESCRIPTION OF DRAWINGS

These and further features of the present invention will be apparent with reference to the following description and drawings, wherein:

FIG. 1 is a schematic diagram of a conventional GMAW welding system;

FIG. 2 is a side view of a welding nozzle in accordance with the present disclosure;

FIG. 3 is a perspective view of a welding nozzle in accordance with the present disclosure;

FIG. 4 is a cross-sectional view of the welding nozzle illustrated in FIG. 2;

FIG. 5 is a schematic, partial illustration of welding nozzle configurations in accordance with the present disclosure;

FIG. 6 is a schematic illustration of various gas port geometries in accordance with the present disclosure;

FIG. 7 is a schematic illustration of a nozzle having a uniformly spaced arrangement of gas ports in accordance with one exemplary embodiment of the present disclosure;

FIG. 8 is a schematic illustration of a nozzle having an irregularly spaced arrangement of gas ports in accordance with another exemplary embodiment of the present disclosure;

FIG. 9 is a cross-sectional view of a portion of a welding nozzle having a converging-diverging gas port geometry in accordance with the present disclosure;

FIG. 10 is an enlarged, closeup view of the converging-diverging gas port geometry illustrated in FIG. 9;

FIG. 11 is a schematic illustration of a welding nozzle for use with a dual wire welding device in accordance with the present disclosure; and

FIG. 12 is a schematic illustration of a welding nozzle according to another embodiment for use with a dual wire welding device in accordance with the present disclosure.

### DETAILED DESCRIPTION

In the detailed description that follows, corresponding components have been given the same reference numerals regardless of whether they are shown in different embodiments of the present disclosure. It is to be understood that the following detailed description is merely exemplary, and is intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Herein, the terms “substantially,” “about,” and variations thereof are intended to note that the described features are equal or approximately equal to a value or characteristic, as desired, reflecting tolerances, conversion factors, rounding off, measurement error and the like, and other factors. For example, the term “substantially flat” surface is intended to denote a surface that is flat or approximately flat. As another example, the terms “substantially”, “about”, and variations thereof can denote values or characteristics that are exact or within 15% of exact, for example within 10% of exact, or within 2% of exact.

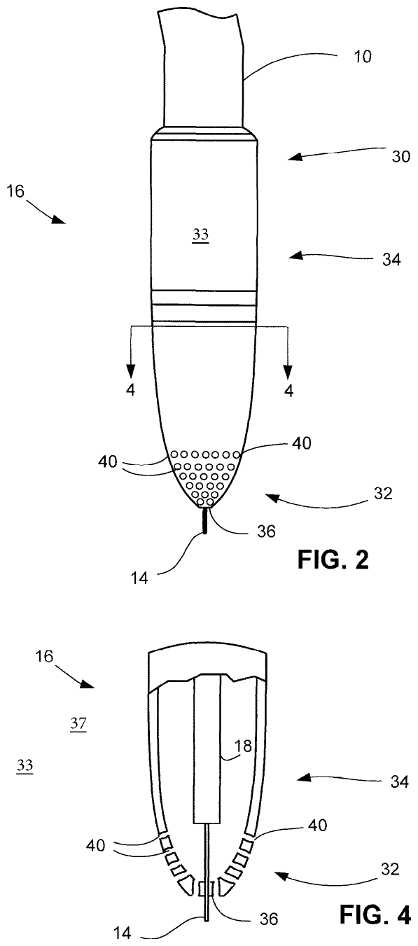

With reference to FIGS. 2-4, a welding nozzle 16 for a welding torch or gun 10 is shown. The nozzle 16 comprises a body including an upper portion 30, a lower portion 32, and a central portion 34 therebetween. In general, the nozzle 16 includes a circumferential side wall 33 extending between the upper portion 30 and the lower portion 32. The side wall 33 intersects an end wall 35 at a distal end of the lower portion 32. The side wall 33 and the end wall 35 define and substantially enclose an internal volume 37 (FIG. 4), where a contact tip 18 is disposed. The upper portion 30 is configured to engage with an end portion (e.g., a conductor tube) of the welding torch or gun 10. The nozzle 16 can be connected to the end portion of the welding gun 10 via cooperating threaded portions, friction or slip fittings, or any other suitable connecting or engaging mechanism. As shown, the end wall 35 of the lower portion 32 defines an electrode receiving aperture 36 through which the consumable electrode or welding wire 14 is extended during welding. In some embodiments, it is contemplated that the end wall 35 (defining the aperture 36) may comprise a low friction material (e.g., an enamel coating) to prevent burnback, i.e., to prevent the wire 14 from sticking to the aperture 36. It is also contemplated that the end wall 35 may comprise a high temperature, low-friction glass material defining the receiving aperture 36. As described more fully below, the upper portion 30, lower portion 32 and central portion 34 may assume a wide variety of outside shapes and configurations.

In one embodiment, the lower portion 32 is tapered such that a diameter of the nozzle 16 gradually decreases from the central portion 34 toward the lower portion 32. It is contemplated that a diameter of the central portion 34 and the lower portion 32 (e.g., the circumferential side wall 33 thereof) be substantially the same in other embodiments. In the illustrated embodiment, the circumferential side wall 33 and the end wall 35 of the lower portion substantially enclose the contact tip 18 therein. This aspect of the present disclosure is particularly beneficial for preventing spatter (generated during welding) from entering an internal volume 37 (FIG. 4) of the nozzle 16, where the contact tip 18 is disposed. In other words, because the nozzle 16 substantially encloses the contact tip 18 from the surrounding environment, the contact tip 18 will be protected from spatter, thereby decreasing the likelihood of burnback induced by spatter adhesion. In addition, because the nozzle 16 substantially encloses the contact tip 18, the contact tip 18 will be less exposed to higher temperatures emanating from the weld zone, decreasing the likelihood of premature contact wear.

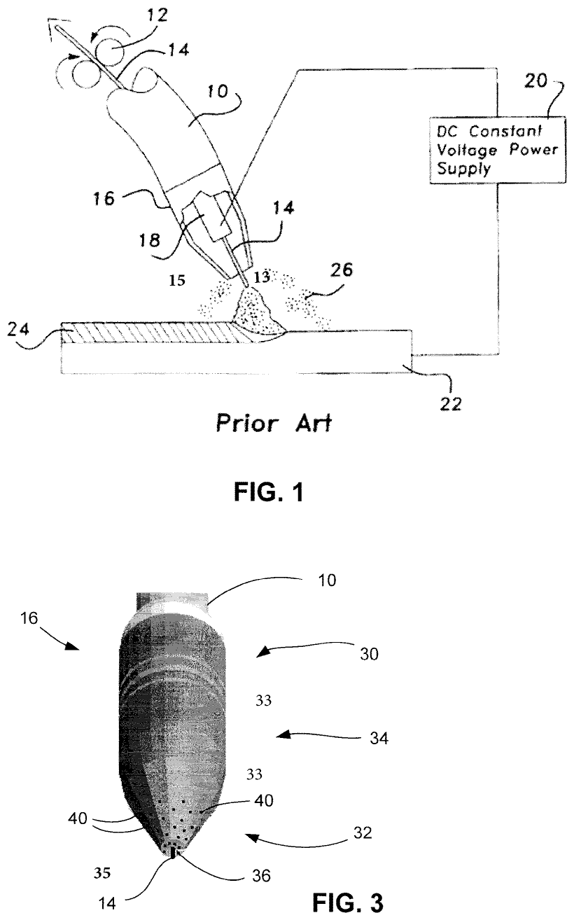

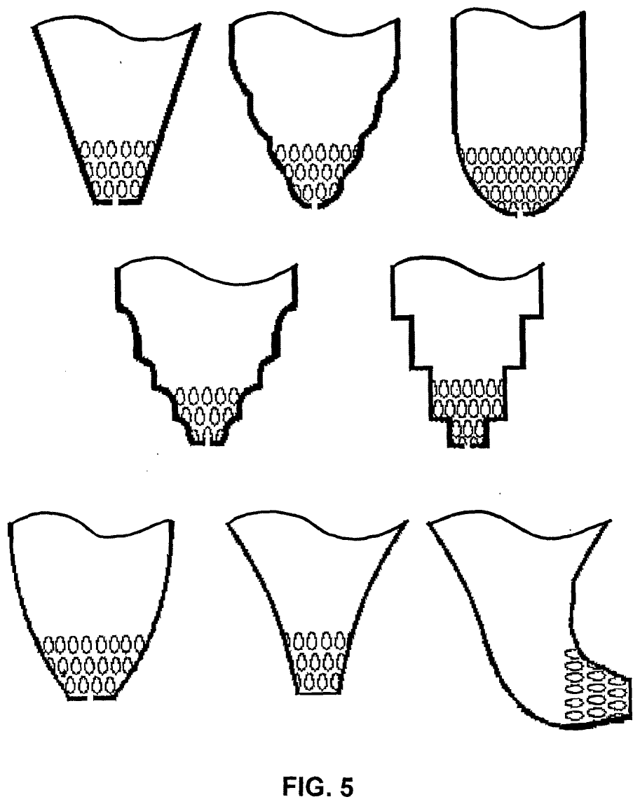

This aspect of the present disclosure distinguishes conventional welding nozzles, which define an orifice 17 (FIG. 1) through which spatter may enter and adhere to the contact tip or an interior surface of the nozzle. It is to be appreciated that the lower portion 32 of the nozzle may include a number of tapered outer configurations, including, but not limited to those illustrated in FIG. 5.

It should also be appreciated that in such embodiments wherein the lower portion 32 is tapered, the reduced outer diameter or lateral dimension of the lower portion 32 can provide greater joint accessibility, for example, when performing welds in tight spaces (e.g., a corner weld etc.). In some embodiments, it is contemplated that the lower portion 32 may embody a different material from the central and upper portions 34 and 30. For instance, the lower portion 32 may comprise a spatter resistant and/or a low friction material, e.g., enamel, glass, machined ceramic, etc. It is also contemplated that the lower portion 32 (or the end wall 35 thereof) may be provided as a separate, replacement component or an aftermarket item compatible with conventional gas nozzles, e.g., dimensioned to engage with and enclose an orifice 13 (FIG. 1) of a conventional type of gas nozzle.

In addition, the end wall 35 (portions immediately adjacent and surrounding the electrode receiving aperture 36) preserves a location of the welding wire 14 passing therethrough, in contrast to conventional nozzles wherein the welding wire 14 (e.g., a distal end thereof) may wander around proximate the opening 13 (FIG. 1) of the nozzle. In other words, the end wall 35 helps positively locate the electrode or welding wire 14, which improves welding performance by avoiding issues related to off-seam welds as well as improving travel speed. This is particularly beneficial in robotic applications, by maintaining the tool center point (TCP, i.e., the position of the wire with respect to the end of a robotic welding arm).

Additionally, this aspect of the present disclosure facilitates an extended contact tip to workpiece distance, because unlike conventional nozzles, the contact tip may be located in a more recessed, upstream location within the nozzle 16 (e.g., upstream and spaced from the electrode receiving aperture 36, which serves to positively locate the wire). As such, it is contemplated that a multitude of different contact tip to work piece distances may be devised, enabling the electrical characteristics of the weld to be altered. This may be beneficial, for example, to reduce the welding current required, increase welding deposition rates, reduce weld distortion potential, increase welding speed, utilize smaller diameter welding wires, or different contact tip configurations (e.g., a contact comprising less conductive material, a smaller contact tip, or an elongated, skinnier contact tip, etc.). It is also contemplated that contact tips comprising different materials may be utilized in conjunction with the nozzle, for example, a contact tip comprising tungsten material or other conductive materials.

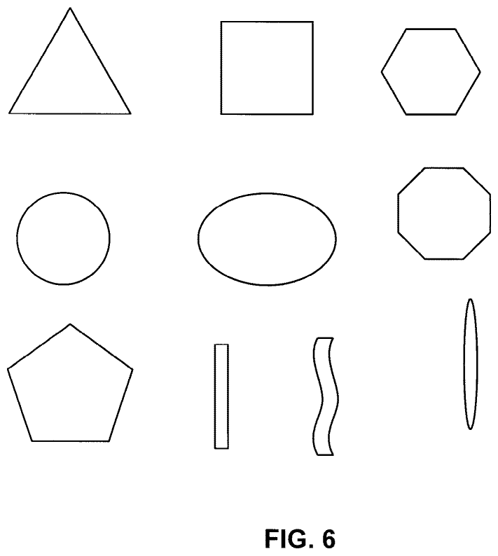

In one embodiment, the circumferential side wall 33 and/or the end wall 35 of the lower portion 32 may include or otherwise define a plurality of gas ports 40 (also referred to as gas diffusion holes or openings). In particular, each gas port 40 may extend between an inner surface of the nozzle and an outer surface thereof. It is to be appreciated that the gas ports 40 can be arranged in a variety of configurations and can include a variety of geometries without departing from the scope of the present disclosure. For example, the gas ports 40 can assume a wide variety of different shapes and configurations, including, but not limited to, the various examples shown in FIG. 6. In some embodiments, one or more of the gas ports 40 can be oriented such that a vector normal to a surface of the nozzle (e.g., immediately adjacent to the respective port) passes through the port 40. Yet, in other embodiments, the gas ports may be oriented and skewed relative to an outer surface of the nozzle or a longitudinal axis of the nozzle 16. In addition, the gas ports 40 can be defined within the sidewall 33 and/or the end wall 35 at a variety of angles in order to direct and more positively locate the shielding gas flow therethrough.

In one embodiment, the gas ports 40 are sized in order to prevent welding spatter from passing through the nozzle 16 into the area adjacent the contact tip 18. In one embodiment, the nozzle 16 can include gas ports 40 of varying sizes and/or geometry which may be amenable to or appropriate for customized applications. In some embodiments, the number of gas ports 40 may be increased to increase shielding gas coverage (i.e., increase the volume of shielding gas passing therethrough), or decreased to decrease shielding gas coverage (i.e., decrease the volume of shielding gas passing therethrough).

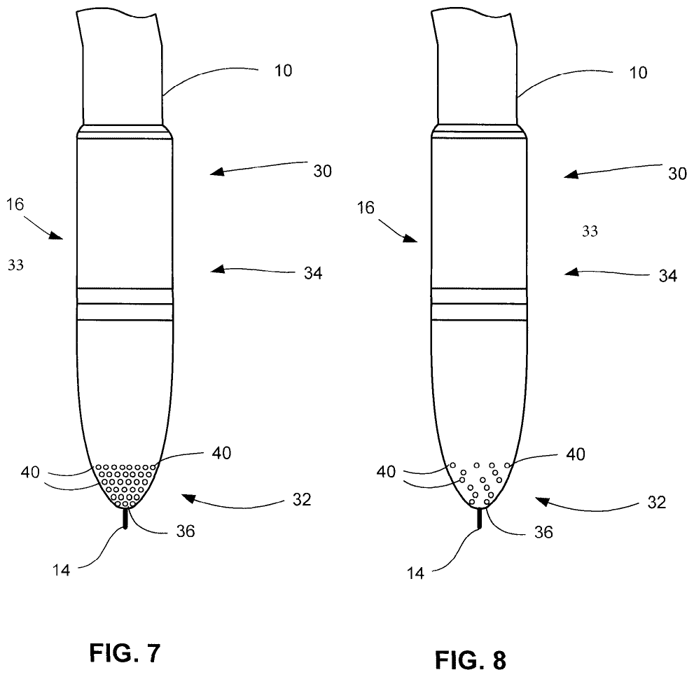

In one embodiment, the gas ports 40 can be arranged at regular intervals and/or with regular spacing (FIG. 7) within the lower portion 32 (i.e., the circumferential side wall 33 and/or the end wall 35). Alternatively, the gas ports 40 can be arranged asymmetrically about the lower portion 32 (i.e., the circumferential side wall 33 and/or the end wall 35) with irregular spacing (FIG. 8). It is to be appreciated that the gas port geometry, size and/or spacing can be optimized to more positively locate the shielding gas flow therethrough. This may be especially advantageous to decrease the overall volume of shielding gas used during a welding operation. In one embodiment, the shielding gas usage can be reduced to a range of about 35 to 50 cubic feet per hour.

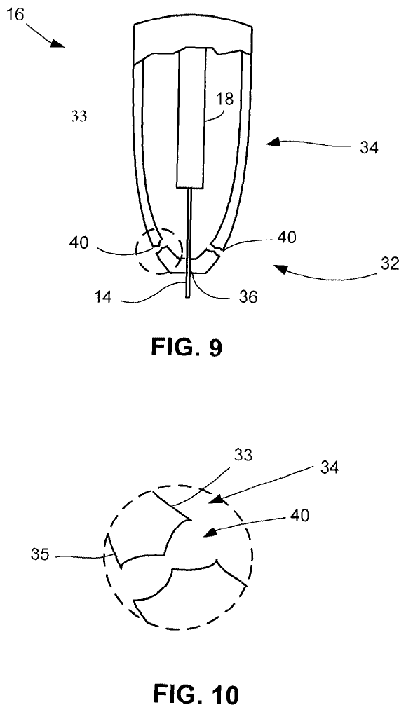

FIG. 9 and FIG. 10 illustrate a portion of a sidewall 33, which defines a gas port 40 that is substantially hyperbolic in cross section. In other words, in accordance with one embodiment, one or more of the gas ports 40 can include a converging-diverging geometry (i.e., having a cross section which decreases between an inner surface 33a of the sidewall 33, up to a midpoint 33b of the sidewall 33, and then increases from the midpoint 33b of the sidewall 34 to an outer surface 33c of the sidewall 33, as shown). It is to be appreciated that this gas port geometry can assist in more positively locating the shielding gas flow therethrough. In addition, this arrangement can also be effective to decrease the overall volume of shielding gas used during a welding operation.

It is to be appreciated that the nozzle 16 can be made from a number of suitable materials, including, but not limited to ceramics (e.g., a green machined ceramic material), raw materials, such as magna, carbon fiber (e.g., a carbon fiber composite), copper, tin, a heat resistant plastic, aluminum, steel, stainless steel (e.g., enameled stainless steel), appropriate alloys, and the like. Preferably, the nozzle 16 is made of a welding spatter resistant material or a material coated with a welding spatter resistant coating, to prevent spatter from sticking to the outside of the nozzle 16. In some embodiments, it is contemplated that the nozzle 16 may comprise a high-temperature resistant enamel coating thereon that serves to preclude spatter adhesion thereto.

As noted above, the lower portion 32 of the nozzle 16 prevents weld spatter from entering into the nozzle 16 by substantially enclosing the contact tip 14 therein (via the circumferential side wall and end wall thereof). In some embodiments, the end wall 35 may comprise a planar wall substantially orthogonal to a longitudinal axis L (FIG. 4) of the nozzle. Yet, in other embodiments, it is contemplated that the end wall 35 may assume a wide variety of different shapes and configurations, for example a rounded end wall 35, a pointed end wall 35 (wherein the circumferential side wall converges to a point). In some embodiments, as noted above, it is contemplated that the lower portion may comprise a substantially uniform diameter (and not be tapered) and intersect the end wall in the form of a planar wall (orthogonal to the longitudinal axis L). In such embodiments, it is contemplated that the end wall may define a plurality of gas ports 40 therethrough.

The nozzle 16 can be formed or otherwise fabricated using a number of techniques, including, but not limited to casting, machining, 3D printing, etc. It is to be appreciated that the method of fabricating the nozzle will depend on the material of the nozzle.

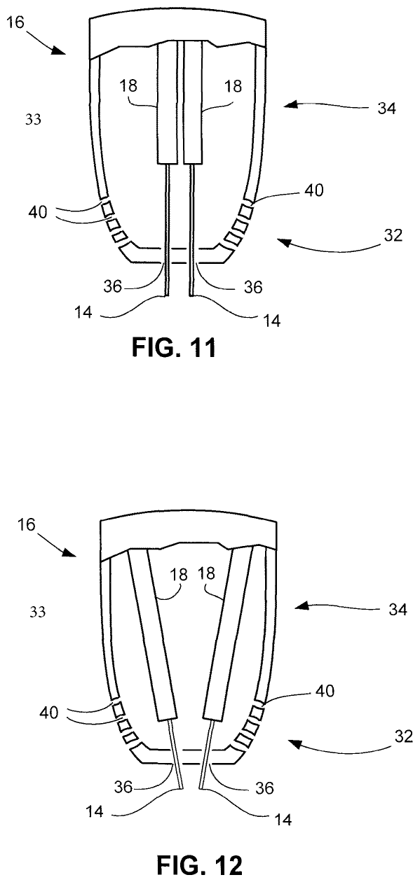

While the various inventions described herein have been described with respect to single electrode or welding wire embodiments, it is to be appreciated that the scope of the present disclosure is also applicable to dual welding wire embodiments. For example, FIG. 11 and FIG. 12 illustrate exemplary nozzle embodiments used with dual welding wire contact tips 18. As described above, the nozzle 16 can include an upper portion 30, a lower portion 32 and a central portion 34 disposed therebetween. In the illustrated embodiment, the contact tips 18 are oriented parallel to one another. It should be appreciated that the orientation of the contact tips 18 may be oriented in a different manner from that which is shown, for instance, by defining an acute angle therebetween. In each of these embodiments, the nozzle 16 can include a pair of electrode receiving apertures 36 as shown. In addition, and as is described more fully above, each nozzle can include a plurality of gas ports or gas diffusion holes 40.

Although, particular embodiments of the invention have been described in detail, it is understood that the invention is not limited correspondingly in scope, but includes all changes, modifications, and equivalents coming within the spirit and terms of the claims appended hereto. In addition, it is to be appreciated that features shown and described with respect to a given embodiment may also be used in conjunction with other embodiments.

What is claimed is:

1. A welding nozzle comprising:
a body having an upper portion and a lower portion, said upper portion being configured to engage with an end portion of a welding torch or gun,
wherein the lower portion comprises a circumferential side wall and an end wall substantially enclosing an interior volume of said welding nozzle, said end wall defining an electrode receiving aperture.

2. The nozzle according to claim 1, wherein one or more gas ports extend through at least one of the circumferential side wall and the end wall.

3. The nozzle according to claim 2, wherein the gas ports are dimensioned to prevent welding spatter from passing therethrough.

4. The nozzle according to claim 2, wherein at least one of the gas ports is oriented such that a vector normal to the respective wall defining the at least one of the gas ports is not parallel to a longitudinal axis of the nozzle.

5. The nozzle according to claim 2, wherein at least one of the gas ports is oriented such that a vector normal to the respective wall defining the at least one of the gas ports is not perpendicular to a longitudinal axis of the nozzle.

6. The nozzle according to claim 2, wherein the gas ports are spaced at regular intervals.

7. The nozzle according to claim 2, wherein the gas ports are spaced at irregular intervals.

8. The nozzle according to claim 2, wherein at one of the gas ports has a converging-diverging cross-section.

9. The nozzle according to claim 1, wherein the upper portion includes a means for removably attaching the nozzle to an end portion of the welding torch or gun.

10. The nozzle according to claim 1, wherein the nozzle is comprised of a welding spatter resistant material.

11. The nozzle according to claim 1, wherein at least a portion of the lower portion is tapered such that a diameter of the nozzle decreases from the upper portion to the lower portion.

12. A welding nozzle comprising:
an upper portion engageable with an end portion of a welding torch or gun; and
a lower portion, said lower portion defining (i) an electrode receiving aperture and (ii) a plurality of shielding gas ports.

13. The welding nozzle according to claim 12, wherein at least one of the shielding gas ports is oriented such that a vector normal to a surface defining the at least one of the shielding gas ports is not parallel to a longitudinal axis of the nozzle.

14. The welding nozzle of claim 12, wherein the lower portion is tapered such that a diameter of the nozzle decreases from the upper portion to the lower portion.

15. A method of assembling a welding gun or torch with the nozzle of claim 1, said method comprising connecting the nozzle to the end portion of the welding gun or torch.

16. A dual electrode welding gun or torch comprising:
a first contact tip and a second contact tip, said first and second contact tips each supporting a consumable electrode;
a welding nozzle substantially surrounding the first and second contact tips, said welding nozzle including:
an upper portion engageable with an end portion of the welding gun or torch; and
a lower portion, said lower portion defining (i) a pair of consumable electrode receiving apertures and (ii) a plurality of shielding gas ports.

17. The dual electrode welding gun or torch according to claim 16, wherein the first and second contact tips are substantially parallel to each other.

18. The dual electrode welding gun or torch according to claim 16, wherein the first and second contact tips are not parallel to each other.
